(19) United States
(12) Patent Application Publication
(10) Pub. No.: US 2002/0128933 A1
(43) Pub. Date: Sep. 12, 2002

(54) Interactive method and apparatus for product customization and purchase

(76) Inventors: Michael Day, Philadelphia, PA (US); Justin Lippincott, (US)

Correspondence Address: Charles N. Quinn, Esq., FOX, ROTHSCHILD, O'BRIEN & FRANKEL LLP, 10th Floor, 2000 Market Street, Philadelphia, PA, 19103-3231, US

(21) Appl. No.: 09/963,346

(22) Filed: Sep. 26, 2001

Related U.S. Application Data
(60) Provisional application No. 60/235,687, filed on Sep. 27, 2000.

(51) Int. Cl. G06F 17/60

(52) U.S. Cl. 705/27

(57) ABSTRACT

The present invention provides an interactive medium for customizing virtual motorcycles, existing as rotational images rendered in 3D. This customizing allows customers to manually alter the appearance of a motorcycle, on a computer, by clicking on various motorcycle parts, paint colors, and accessories. Programming is provided to implement this system by CD-ROM or the web. Upon completing a customization, customers can purchase the product. Skilled information is available on-line to facilitate the customization. Also, a forum for auctioning used parts, selling motorcycles, and advertising motorcycle related services is available. Thus, the present invention offers a method and apparatus for visually customizing a motorcycle in an interactive medium, for buying and selling motorcycles and motorcycle accessories on-line, and for receiving mechanically skilled guidance on-line.

### FIELD OF THE INVENTION

The invention relates generally to a method and apparatus allowing consumers to purchase goods and services over the internet, or through CD-ROM software.

### BACKGROUND OF THE INVENTION

The motorcycle industry (specific to Harley Davidson) has grown exponentially over the last few years. Since 1986, Harley Davidson's unit sales have grown at a compound annual growth rate of approximately 24%. Interestingly, most people purchasing a Harley Davidson continue spending money by customizing their bikes with fancy paint designs, wheels, exhaust systems, and various other chrome accessories. Consequently, the customizing industry has also continued to grow, with people replacing parts not actually broken or in need of repair. Instead, changes are driven by stylistic preferences.

When customizing a motorcycle, people have countless magazines and catalogs to sift through, and the overall process can be quite frustrating. Visualizing how a product will look on a bike is difficult, and there is no room for trial and error—chrome accessories cost hundreds of dollars, and labor costs generally run about $50 per hour. Moreover, replacing parts can take weeks or months; no motorcycle owner wants to sacrifice time on the road without being certain their customizing choices are worthwhile. In fact, customers are often faced with disappointment after spending the time and money to customize—unfortunately, there is no turning back.

Thus, a method and apparatus to remedy this problem is needed. By using technology that can manually and visually customize a motorcycle within minutes, customers could avoid wasting their time and money.

There is currently no medium for selling or exchanging used motorcycle parts, presenting another consumer problem. As mentioned earlier, replaced parts are seldom broken or damaged; choosing to purchase customized parts is generally a decision to stylize the motorcycle. Sadly, there is no effective way for customers to sell used parts; most people leave them with the dealership or mechanic, or the parts collect dust in a garage. Consequently, an on-line auction allowing motorcyclists to buy, sell, and trade parts will remedy this problem.

Accordingly, it is an object of this invention to provide a method and apparatus to visually customize motorcycles on a computer as a marketing and sales tool for dealerships and specialty shops, thus providing better service and easier shopping for customers while increasing dealer efficiency and productivity.

Another object of this invention is to provide a method and apparatus for electronic shopping and visual customization, allowing customers to harness their creativity and to see products quickly and easily, thus encouraging customers to make purchases.

A third object of this invention is to provide technology alleviating the stress associated with motorcycle customization, since customers, presently, cannot view the result of their customization project until physical completion of the project.

A further object of this invention is to provide a method to reduce the amount of time spent customizing and shopping for parts, as well as to provide customers a means to sell their otherwise discarded parts.

### SUMMARY OF THE INVENTION

The present invention offers motorcycle enthusiasts a method and apparatus to visually customize three-dimensional (3D), rotational motorcycle views with one click of the mouse. The method is implemented with web and CD-ROM technology. In addition, custom products are offered for sale directly on the web-site, provisions are made allowing for the installation of custom parts, and an auction feature is provided for the sale of used parts.

In one of its aspects this invention provides a method for marketing motorcycles and motorcycle replacement, enhancement and customizing parts where the method includes the steps of assembling a machine readable database catalog of information in pictorial, graphic and textural form for motorcycles and motorcycle replacement, enhancement and customizing parts. Such information desirably includes graphically displayable photographs of the parts, prices of the parts, numbers of the parts, identification of the make and model years of motorcycles with which the replacement, enhancement and customizing parts are compatible, instructional materials regarding use of the parts, shipping options which are available for transporting the parts to the customers, inventory data regarding the number of individual parts and inventory and ready for sale and supplier information for reordering parts to replenish the inventory.

The method preferably further includes verifying, responsively to a putative customer inquiry received via the Internet or telephone, the putative customer's identity and good standing for access to the database and communicating the same to the customer via the Internet or the telephone. The method further preferably includes providing the verified customer with a menu to select either a base motorcycle product to which will be added repair/replacement, enhancement and/or customizing parts or from which to directly order repair, enhancement or customizing parts.

For a customer selecting the base motorcycle option, the method preferably further embraces graphically displaying the selected base motorcycle, providing a menu from which repair/replacement, enhancement and customizing parts may be selected, adding the selected repair/replacement, enhancement or customizing part to the displayed motorcycle and graphically displaying the same, in response to a customer selection input signal decrementing available inventory figures to reflect the customer's selection, in response to any customer deletion input signal deleting any previously selected repair/replacement, enhancement or customizing part and adjusting the available inventory to reflect the deletion, and repeating these steps for customers selecting the base motorcycle option until receiving a signal from the customer to terminate the addition of selected repair/replacement, enhancement or customizing parts to the displayed motorcycle. The method further preferably embraces receiving a confirmatory ordering signal from the selecting customer which is indicative of an order being placed for the selected repair/replacement, enhancement or customizing parts and preferably further embraces the step of checking credit, payment and shipping data for such selecting customer and shipping the selected parts to the customer if the credit and payment checks are satisfactory.

The customizing feature operates as follows: a menu is provided for a consumer to select a stock motorcycle, which is viewed on the computer; a second menu is provided for the consumer to select custom features, which are then incorporated into the three-dimensional, rotational views displayed on the computer. The customized view files can be continually modified and saved. Personal information is also received, creating accounts for the payment of customizing time.

The web-site is hosted on a dedicated server running Microsoft Internet Information Server 4, the combination providing security for the user accounts. The auctions are implemented using CGI-scripting combined with Active Server Page programming. The one click customizing combines 3D rotational rendering with Active Server Page programming. 3D object manipulation is achieved with Apple QuickTime VR, using 3D objects created in 3D Studio Max. All information communicated between the user and system databases (event calendars, etc) are accomplished with SQL calls through VBScript and ASP to a Microsoft SQL database. Basic cascading stylesheets provide the look and feel of the page. All sensitive information is transferred using SSL (secure-server link) technology and 128-Bit encryption (legal in U.S. only). The users' personal settings are stored as cookies on their local machine.

The invention is also implemented on a CD-ROM, using C++ programming with images rendered into rotational 3D and C++ programming.

### BRIEF DESCRIPTION OF THE DRAWINGS

For the purpose of illustrating the invention, there is shown in the drawings a form which is presently preferred, it being understood, however, that this invention is not limited to the precise arrangements and instrumentalities shown.

FIG. 1 illustrates one embodiment of the computer display appearing on the left side of the bottom frame of the web-site home page;

FIG. 2 is a block diagram of major software blocks of this invention;

FIG. 3 illustrates a block diagram of the software control and protocol flow suitable for implementing a portion of one embodiment of this invention.

### DETAILED DESCRIPTION OF THE INVENTION

The customizing, purchasing and other informational features provided with this invention are provided over the web, or by purchasing the CD-ROM. The CD-ROM allows customers to avoid the frustrations surrounding the internet; there are no connection worries and no waiting after a selection is made. The web offers more convenience and allows for more frequent system updates. Furthermore, the web provides a truly virtual environment where products are directly purchased and dealers are contacted in seconds. The web provides a more comprehensive service as well; allowing customers to schedule an appointment with an on-line mechanic, inquire with questions and concerns, and visit web pages advertising motorcycles for sale. Most importantly, the home-page offers a service demonstration, where web-surfers quickly receive an overall feel for the customizing service offered before committing to a membership.

Serving as a focal point for the motorcycle industry, the home-page includes links to other valuable sites, such as A.B.A.T.E. (Arkansas Bikers Aimed Towards Education) and B.A.C.A (Bikers Against Child Abuse). Consequently, visitors receive an abundance of useful motorcycle related information.

Secondly, the site provides a medium for dealers and repair-shops to advertise their businesses. Ads appear on the site as banner links, serving three purposes: to generate revenue for the site, to provide easy access to dealers, and to offer dealers an effective marketing venue. The home-page is comprised of two frames, dividing the screen horizontally. All links to other sites open inside the bottom frame, so visitors never actually leave the web-site. The top frame has a “home” button, returning visitors to the home page. This feature keeps potential customers connected with the site, and allows the customer superior navigational ease. The site logo continuously appears in the top frame, alerting customers to the contact site.

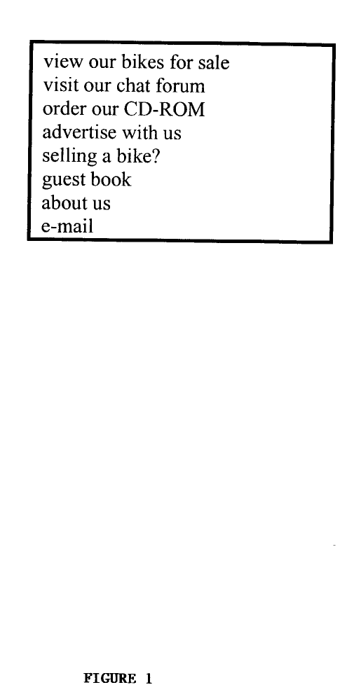

FIG. 1 illustrates one embodiment of the display appearing on the left side of the bottom frame of the home page. Each link transports the visitor to a new window opening on the right side of the bottom frame. The top frame remains unchanged, offering visitors easy navigation through the site. The following provides a brief description of each link:

View Bikes for Sale

This link opens a page featuring motorcycles for sale. The page displays a chart with each row dedicated to a specific advertisement. Each ad lists the bike's year, condition, model, and detailed specifications. Those placing ads are offered the option of including a photograph of the bike, viewable through a separate link. Opportunities to contact the seller are provided.

Visit the Chat Forum

Appointments are provided to chat with an on-line mechanic. All mechanics are guaranteed professionals, offering valuable information to those interested in customizing a motorcycle. The motorcycle customization process is expensive and time consuming; this service offers potential customers an unbiased opinion concerning what purchases and options practically suit there desires.

Upon entering the “visit our chat forum” link, customers are taken to an intermediate page providing detailed information explaining the chat forum's purpose and goal. Here, the customer is provided two options: schedule an appointment or enter the forum. When scheduling an appointment, visitors are offered a list of available time-slots. Upon making an appointment, the customer's billing information is taken and verified, whereby the appointment is confirmed and the customer receives a user name and password providing access for the specific appointment selected.

People with a scheduled appointment are instructed to click the “visit our chat forum” link five minutes prior to their scheduled appointment. The customer is then prompted to enter the appropriate user name and password, whereupon the java applet created in the present invention serves as the chat forum running within the web browser.

Order the CD-ROM

This link provides an intermediate page explaining the CD-ROM's design, benefits, and disadvantages. Within this link the customer chooses to return to the home page or to proceed to the ordering page. If ordering, the visitor is offered an on-line order form, requesting specific information such as: name, address, phone number, e-mail, delivery choice, number of compact discs desired, and payment options.

Advertise with Us

The site offers advertising options to businesses, organizations, and dealerships. An information page is provided within this link explaining the advertising process and pricing packages. Web-page statistics are offered, showing the number of hits the site receives and showing site growth over time. Advertising rates depend on the type of advertisement placed. One type is the advertising page, listing various businesses and organizations. This option has a set rate, since each customer is given the same size ad. The advertising page has no e-commerce link; customers receive contact information, and all transactions take place independently of the site. For a higher fee, a link is provided within the ad. This link opens within the web-site, so visitors do not leave the site while visiting the link.

Sell your Bike with Us

The web-site offers a comprehensive service to motorcycle enthusiasts. The “sell your bike” link allows riders to advertise their bike on-line. The link takes customers to an explanatory page. This explanatory page has two links at the top: “home” and “advertise with us.” The latter link connects the visitor to the order form. Here, customers are prompted to enter their personal information and credit card data. The bottom of the form includes questions about the bike being advertised, with a text box allowing for the entry of a short description. After informational entry, a submit button initiates credit processing. A final confirmation page alerts the customer of request approval. This page offers the submission of photos to accompany the ad, which can be submitted via e-mail.

Guest Book

The guest book provides another forum for visitors to request specific information, and to provide comments. Receiving comments from visitors, through the guest book, provides a means for this service to continually improve.

About Us

This page provides an opportunity to personalize the business as a service provided by two average motorcycle enthusiasts. This page includes background information, pictures, and reasons for beginning the business. The bottom of the page has two links: one leading back to the home page and one allowing existing members to log-in.

E-Mail

E-mail links are scattered throughout the web-site to ensure a high level of customer satisfaction. The guest book and e-mail pages provide an opportunity to learn more about the visitors while addressing their concerns.

Demo Page

A demonstration page is provided that parallels the design and structure of the actual customizing page, offering the potential customer a sample of the customization service to help encourage the purchase of this service.

The demo page is the real thing, but functionality is deactivated. Visitors cannot customize the virtual motorcycles here; instead, 3-D views of motorcycles are designed with customized products in a cyclical manner, demonstrating what will actually occur if customers choose to become a member and use the customizing service. This looping design has ten pre-determined changes illustrating system capabilities. Also, the top of the demo page has a “home”0 button and a link for those interested in becoming a member.

New Member Link

The new member link takes visitors to a sign-up page, which the visitor can complete in less than five minutes. This page displays different purchase packages, offered to suit differing customer needs. After receiving the necessary information and credit card processing, a confirmation page appears, thanking the new member and offering a user name and password necessary for logging-in. A “home” link and a “login” link appear, since confirmation of the transaction results in immediate access to the customizing page.

Member Log-In

The “member log-in” page shows the business logo with two text boxes in the middle of the page: one for the member's user name and the other for the password. The bottom of this page has three options: a home button, a link returning visitors to the login page, and a link for those who may have lost their user name or password. Clicking the “lost user name/password” button takes members to a page prompting them to enter their e-mail address. After submitting this information, a return e-mail with the correct user name and password is provided.

The Customizing Page

The customizing page has a left and a right frame. The left frame shows two 3D motorcycles, one rotating on a horizontal axis and the other, appearing directly below, rotating on a vertical axis. Below these virtual bikes appears three important options: a “back” button, a “reset” button, and a “save” button. Clicking “back” removes the previous customizing selection. Clicking “reset” removes all customizing selections, thus returning the bike to its stock appearance. In this way, the user is provided with quick and easy customization. Members can print any frame for their records. Clicking “save” opens a new window. Here, customers choose a filename for the view being saved. The file is not saved to a disk; rather, the file exists in a “saved files” menu in the right frame so customers can choose to continue their work at a later date.

The right frame prompts members to select a specific motorcycle to customize by providing a drop down menu listing various stock bikes. The list is comprised of many different styles of bikes ranging over a fifteen year period: 1985-2000. Once a model is chosen, the virtual replicas appear in the left frame.

The right frame also lists the customizing options, broken down into separate categories. More specifically, the frame includes the following drop down menus: paint colors, handlebars, wheels/tires, exhaust pipes, leather accessories, and miscellaneous products. Clicking a menu displays a list of available products. When a product is selected, the two bikes in the left frame change accordingly, incorporating the custom selections into the motorcycle shown. The custom modification remains on the bike until the member selects “undo” or “reset.” As a result, customers have the power to create many different designs and styles.

Besides choosing a specific model of motorcycle to customize, members may also decide to view a product close-up. The right frame offers two options: select a stock bike and view a product close-up. If the member checks the “close-up” box, then selecting a product opens a new window. This pop-up window displays the product as a 4×4 inch GIF file. This feature is implemented with a “pop-up” window to avoid interference with the layout of the customizing page.

Store/Dealer Information

The customizing page also gives customers purchasing power. A drop down menu is available, listing every state in the country. Selecting a specific state transports the customer to a page listing shops and dealers in that area, with accompanying contact information.

Participating companies sell their products directly through the site. Clicking the “purchase a product” icon takes the visitor to a new page, listing all the products available for sale. Accompanying this page is the usual order forms and credit card processing features.

Monitoring Consumer Traffic

The home page contains a hit counter, disclosing the amount of traffic the site receives. The number on this counter, however, is not one hundred percent accurate, since clicking the refresh button on the web browser adds another number to the count. Also, multiple visitors are not calculated as one hit; consequently, if one person visits the site ten times in one day, the counter will recognize ten hits. As such, these hit counters merely represent site traffic.

For more precise monitoring, a web address provides potential advertising clients with specific hit calculations. The hit information is taken directly from the site server.

Security Information

Two security issues exist with this web-site service. First, customers must feel secure when entering their personal information and credit card data. A “consumer confidence” page is provided explaining that customer information is never disclosed to any organization, and transactions always occur via a secure server that encrypts the credit card data.

At the same time, membership abuse must be minimized (i.e. members giving their user names and passwords to others). To control abuse, memberships are sold by time units of use. For example, a customer buys twenty hours of customizing time. So, even if members allow others to use their log-in information, no abuse occurs as use is limited to the time purchased.

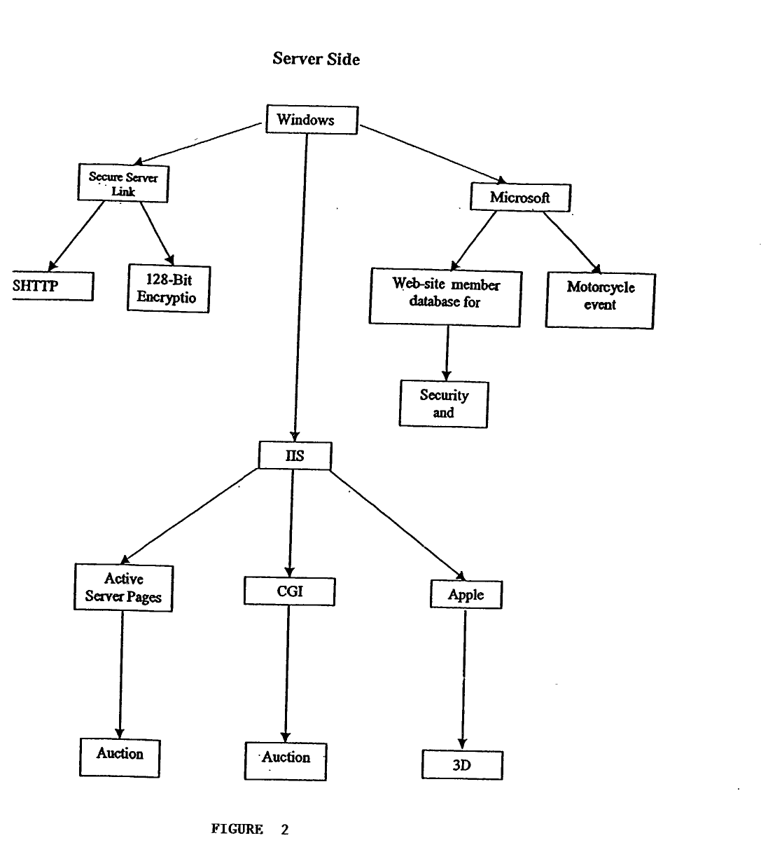

As described below, and further illustrated in FIG. 2, the web and CD-ROM systems include the following programming to implement the features mentioned above:

Windows NT, IIS, and Security

The site is hosted on a dedicated Windows NT 4.0 Server running Microsoft Internet Information Server 4—this combination provides for security of the user accounts. Windows NT Server 4.0 integrates naturally into the web-site—in other words, the site becomes simply another part of the operating system.

Microsoft Internet Information Server (IIS) is built into the Microsoft Windows NT Server operating system. IIS makes it easy to share documents and information across the Internet. It is the fastest web server for Windows NT, and it is completely integrated with Windows NT Directory Services. This combination of speed and reliability prevents technical issues from hindering the implementation of the more complicated programming.

After customers complete the site's forms (membership to the site, purchases, etc.) and click submit, data is protected during transit through the Internet by a process called encryption. Encryption uses a mathematical formula to scramble data into a format unreadable by anyone who might intercept the data. Residents of the United States or Canada have some choice as to what level of encryption to use. Encryption strength is measured by the length of its “key,” expressed in bits. The longer the key, the greater the strength of the encryption. The site of the present invention transcends the usual 40-Bit keys and uses 128-Bit Strong encryption. In fact, data encrypted with a 128-Bit key is approximately 309,485,009,821,345,068,724,781,056 times stronger than data encrypted with a 40-bit key.

The present invention also protects its customers by using SHTTP (secure hyper text transfer protocol). This is the most common and highest form of security presently available for data transfer over the web. SHTTP is implemented by designing a simple forms page transferred over the Secure Server Link (SSL). The information goes to the server, and the server checks the database, verifying USERNAME and PASSWORD. Access is allowed upon verification.

IIS 4.0 includes integrated searching capabilities allowing users to create custom search forms with Active Server Pages and SQL queries to search for information on the Web server. For the present invention, such capabilities allow search engines to simplify the process of looking for specific new and used products.

Active Server Pagers

An Active Server Page (ASP) is an HTML page including one or more scripts (small embedded programs) processed on a Microsoft Web Server before the page is sent to the user. An ASP is somewhat similar to a server-side or a common gateway interface (CGI) application, as it involves programs running on the server, that tailor the page for the user. Typically, the script in the web-page on the server-side uses input received as the result of the client's request, building or customizing the page on the fly before sending it to the client side. ASP is a feature of the Microsoft Internet Information Server (IIS)—since the server-side script is simply building a regular HTML page, however, it can be delivered to almost any browser.

ASP files are created with VBScript or JScript in an HTML file or by using ActiveX Data Objects (ADO) program statements in the HTML file. Microsoft recommends the use of the server-side ASP rather than client-side scripts, because the server-side script results in an easily displayable HTML page. Client-side scripts (for example, with JavaScript) may not work as intended on older browsers.

With regards to the present invention, Active Server Pages allow versatility and programming power without sacrificing browser independence. As such, client-side scripts are kept to a minimum in the present invention.

CGI Scripting

HTML thrives in a static environment. After putting a page on the web, it essentially remains in place until the user calls up a new page, usually by clicking a hyperlink. HTML combines text and graphics, providing tables and frames allowing one to achieve a specific look or design. When information is processed, such as data entered into a form, the information is sent back over the data stream to the server, which generates a new HTML page and sends it back to the user for display. This process, accomplished via a protocol called CGI, or Common Gateway Interface presents users with more dynamic and interactive sites.

For the present invention, CGI-Scripting serves as the backbone of the auction site—the programming is platform independent and allows both users and administrators to input data. In such a way, users can add their own items to the database and make bids on products.

The Common Gateway Interface provides a means for the browser and the server to communicate and pass information. CGI is great for adding interactivity to a site, and for ensuring that current data is sent to the user at all times. JavaScript and other client-side techniques have limited capabilities, so CGI is necessary in the present invention. Since client-side techniques are implemented in the browser, it is difficult, if not impossible, to remember certain information (other than using a JavaScript cookie). For the present invention, and for these reasons, the CGI application interacts with the auction databases, guest books, and search engines.

3D Rotational Rendering

To implement the customizing technology, static images of motorcycles are rendered into 3D. This is accomplished using a 3D rendering package called Form Z, a general purpose solid and surface modeler having an extensive set of 2D/3D form manipulating and sculpting capabilities.

Apple Quicktime VR

Apple QuickTime VR Authoring Studio software creates interactive virtualreality for this invention, using the images of the motorcycles rendered into 3D. As described herein, and further illustrated in FIG. 3, Apple Quicktime VR turns the computer renderings into realistic and interactive displays with 360-degree views. The five modules in the QuickTime VR Authoring Studio suite cover all of the steps necessary for creating an immersive environment, from controlling camera positions to blending images together. Scenes are then optimized for the web and the CD-ROM. Apple QuickTime VR supports 360-degree views, called panoramic movies, as well as object movies allowing users to view an object from all sides. Objects are fully interactive, with zooming, animation, and hot spots linked to other multimedia objects. Finished QuickTime VR movies are viewed on computers running Mac OS or Windows software through QuickTime Plug-in for web browsers or any application playing standard QuickTime movies. QuickTime VR Authoring Studio is ideal for producing large and complex interactive experiences for CD-ROMs.

SQL

SQL (pronounced “ess-que-el” ) stands for Structured Query Language. SQL communicates with a database, and is the standard language for relational database management systems. SQL statements update data on a database and retrieve data from a database. For this invention, SQL offers the ease and stability necessary for maintaining the web-site, and is used for the “customizing” site member database. In other words, when users enter their personal information for access to the customizing technology, the information is sent to the Microsoft SQL database. Moreover, other services, such as the motorcycle event calendars and dealership directories, are also communicated in this fashion.

CD-ROM and C++

Designing the CD-ROM requires the Apple Quicktime VR display of the images rendered into 3D. C++ intertwines the images with the customizing options. C++ is an object-oriented extension of the C language. C++ is not limited to any particular hardware or system, making it easy to write programs capable of running without changes on practically any machine.

What is claimed:

1. A method for providing a consumer an interactive medium to visually customize and purchase a product using a computer, comprising:
a. providing one menu for said consumer to select a stock product, whereby a view of said stock product appears in said interactive medium;
b. providing a second menu for said consumer to select custom features for said stock product, whereby said custom features are visually incorporated into said view of said stock product, creating a customized view of a customized product;
c. receiving purchase requests from said consumer.

2. The method of claim 1, wherein said purchase requests involve said custom features.

3. The method of claim 1, wherein said purchase requests involve a purchase and installation of said custom features on said stock product owned by said consumer.

4. The method of claim 1, wherein said purchase requests involve said customized product.

5. The method of claim 1, further including:
a. receiving personal and credit card information from said consumer, whereby said consumer is given account information necessary to access said interactive medium to visually customize a product, whereby this act occurs first;
b. receiving said account information from said consumer, accessing said interactive medium to visually customize a product to said consumer, whereby this act occurs second, before providing one menu for said consumer to select a stock product.

6. The method of claim 1, wherein said view of said stock product includes two, three-dimensional rotating images, the first of said images rotating on a horizontal axis and the second of said images rotating on a vertical axis.

7. The method of claim 1, further including:
a. allowing said consumer to select additional custom features from said second menu, whereby said additional custom features are incorporated into said customized view, creating a further customized view of a further customized product, whereby this act occurs after receiving purchase requests from said consumer;
b. providing an option for said consumer to remove said additional custom features, whereby said additional custom features are visually removed from said further customized view; creating said customized view of said customized product;
c. providing a second option for said consumer to reset said interactive medium, whereby said stock product appears in said interactive medium.

8. The method of claim 1, further allowing said consumer to enlarge said customized view of said customized product, for close-up imaging, whereby this act occurs after providing a second menu for said consumer to select custom features for said stock product.

9. The method of claim 1, further including:
a. allowing said consumer to save said customized view, creating a file for later access;
b. allowing said consumer to print said customized view, whereby these acts occur after providing a second menu for said consumer to select custom features for said stock product.

10. A method for marketing motorcycles and motorcycle replacement, enhancement and customizing parts, comprising:
a. assembling a machine readable database catalog of information in pictorial, graphic and textual form for motorcycles and motorcycle replacement enhancement and customizing parts, with such information including for example and not being limited to graphically displayable photographs of the parts, prices of the parts, numbers of the parts, identification of the make, model and year of motorcycles for which said replacement, enhancement and customizing parts are compatible, instructions regarding use of the parts, shipping options for transporting the parts to customers, inventory data regarding numbers of individual parts in inventory and ready for sale, and supplier information for reordering parts to replenish inventory;
b. responsively to a putative customer inquiry received via the Internet or telephone, verifying the putative customer's identify and good standing for access to said database and communicating the same to the customer via the Internet or telephone;
c. providing the verified customer with a menu to select either a base motorcycle product for repair/replacement, enhancement and/or customizing or from which to directly order replacement, enhancement or customizing parts;
d. For a customer selecting the base motorcycle option,
i) graphically displaying the selected base motorcycle;
ii) providing a menu from which repair/replacement, enhancement and customizing parts may be selected;
iii) in response to a customer selection input signal, adding the selected repair/replacement, enhancement or customizing part to the displayed motorcycle and graphically displaying the same;
iv) in response to any such selection signal, decrementing available inventory figures to reflect such selection;
v) in response to any customer deletion input signal, deleting any previously selected repair/replacement, enhancement or customizing part and adjusting the available inventory to reflect such deletion;
vi) repeating the immediately foregoing steps i through v until receiving an signal from the customer to terminate the addition of selected repair/replacement, enhancement or customizing parts to the displayed motorcycle;
e. For a customer selecting the option to order replacement, enhancement or customizing parts,
i) providing a menu from which repair/replacement, enhancement and customizing parts may be selected;
ii) in response to a customer selection input signal, adding the selected repair/replacement, enhancement or customizing part to the customer's order list and graphically displaying the same;
iii) in response to any such selection signal, decrementing available inventory figures to reflect such selection;
iv) repeating the immediately foregoing steps i through iii until receiving an signal from the customer to terminate the addition of repair/replacement, enhancement or customizing parts to the order list;
f. receiving a confirmatory ordering signal from the selecting customer indicative of an order being placed for the selected repair/replacement, enhancement and customizing parts; and
a. checking credit, payment and shipping data for such selecting customer and shipping the selected parts thereto if the credit and payment checks are satisfactory.
